(19) United States
(12) Patent Application Publication
(10) Pub. No.: US 2008/0294705 A1
(43) Pub. Date: Nov. 27, 2008

(54) Performance Improvement with Mapped Files

(76) Inventors: Jens Brauckhoff, Heidelberg (DE); Guenter Zachmann, Rauenberg (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/753,445

(22) Filed: May 24, 2007

(51) Int. Cl. G06F 12/16

(52) U.S. Cl. 707/205; 707/E17.01

(57) ABSTRACT

A method and apparatus for improving system performance by asynchronously flushing a memory buffer with system log entries to a log file. The apparatus and method minimize performance loss by detecting when a memory region that is mapped to a file is about to become full and generate or switch to a new memory region so that activities can be continuously written. A process dedicated to flushing the full memory region is instantiated and terminates once the memory region has been completely flushed to a file. All application and user processes can continue to run without interference or the need to manage the flushing of the memory regions.

### BACKGROUND

1. Field of the Invention

The invention relates to a process for the logging of activities in a computer system. Specifically, the embodiments of the invention relate to the logging of activities by processes into memory mapped files that are flushed asynchronously to the file.

2. Background

Many systems have multiple processors or execution units that each execute separate processes associated with various applications and services provided by a computer system and its operating system. Many applications and services have running processes that generate activities that an administrator or user desire to have logged. Activities are logged for purposes of debugging, error tracking, compilation of usage statistics and similar functions.

The activities to be logged are written to a file in a file system or data management system such as a database. However, writing to a file is a slow process, on the order of milliseconds, and blocks or slows down the process during the write to the file and decreases system performance. However, the file provides a record that is permanent and not lost on system restart or failure.

In some systems, as illustrated in FIG. 1, to improve performance, activities are recorded in a memory buffer 103. The memory buffer is a designated section of system memory or a similar random access storage device having a fixed size. However, the memory buffer 103 is not a permanent storage device and the data in the memory buffer 103 is lost on system restart or failure. The content of the memory buffer is written to a file 107 when it becomes full. The file 107 is stored on a fixed disk 105. The process 101 that fills in the last spot in the buffer 103 or that recognizes that the buffer is full must write the contents of the buffer 103 to the file 107 to free up space in the buffer to write additional entries.

During the writing of the data to the file system, the process carrying out the write is blocked and other processes may be blocked that need to write data to the memory buffer 103. A process or multiple processes are blocked on the order of every 100 to 1000 times that a process attempts to write to the memory buffer 103. As a result, significant system performance degradation occurs.

### SUMMARY

Embodiments of the invention include a method and apparatus for improving system performance by asynchronously flushing a memory buffer with system log entries to a log file. The embodiments minimize performance loss by detecting when a memory region that is mapped to a file is about to become full and generate or switch to a new memory region so that activities can be continuously written. A process dedicated to flushing the full memory region may be instantiated to flush the memory region and then terminates once the memory region has been completely flushed to a file. All applications and user processes can continue to run without interference or the need to manage the flushing of the memory regions.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a system for managing a memory buffer.

FIG. 2A is a diagram of one embodiment of a system for managing a set of mapped memory regions.

FIG. 2B is a diagram of one embodiment of a system for managing a set of mapped memory regions where a second region has been activated.

FIG. 3 is a flowchart of one embodiment of a process for managing the set of mapped memory regions.

FIG. 4 is flowchart of one embodiment of a process for retrieving data from a memory region or a file.

FIGS. 5A and 5B are flowcharts of one embodiment of a process for managing a log file.

FIG. 6 is a diagram of one embodiment of a system for the memory mapped log file.

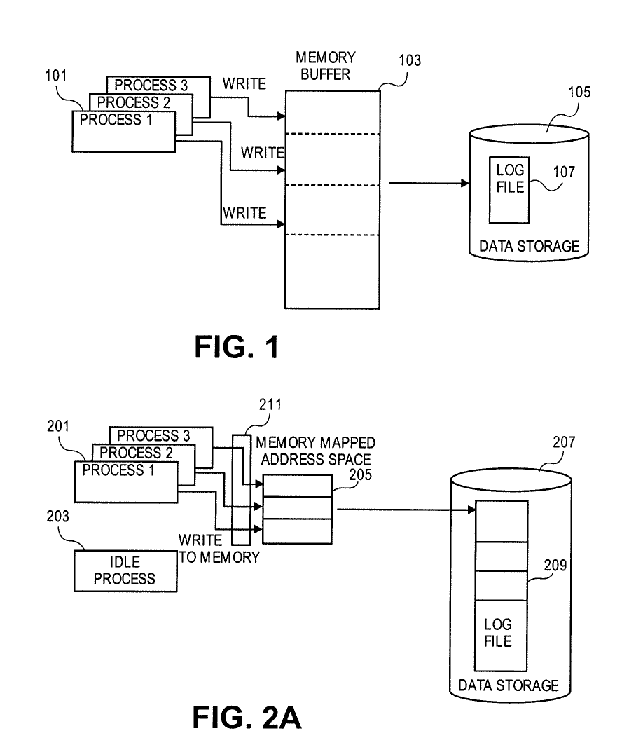

### DETAILED DESCRIPTION

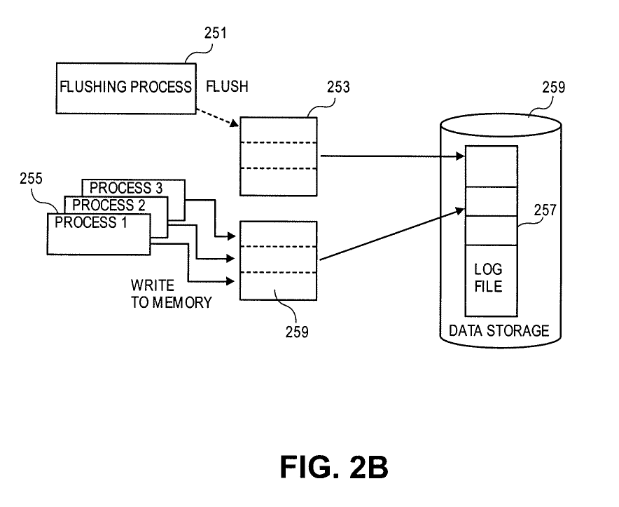

FIG. 2A is a diagram of one embodiment of a system for managing a set of mapped memory regions. The system can have any number of processes 201 executing separate applications or services or different aspects of the same applications or services. Each process 201 can be executed on a separate processor, execution unit or amongst a pool of processors, execution units or similar devices. The processes 201 may each be executing on the same workstation, server or similar system or may be distributed over multiple systems.

In one embodiment, each process 201 or a set of the processes 201 in the system write data indirectly to a log file 209. A system with a single log file 209 has been illustrated, for sake of clarity and one of ordinary skill in the art would understand that any number of log files can be managed each with its own mapped memory regions using the principles and mechanisms described herein. A ‘set,’ as used herein, refers to any positive whole number of items including one item.

Each process 201 logs activities by generating write requests that are serviced by writing the log data to a mapped memory region 205. A mapped memory region refers to a space in system memory that is ‘mapped’ to a portion of a file, in this case the log file. The address space of the memory region may have a one to one correspondence with a section of the address space of the log file.

The write requests generated by the processes 201 are made and serviced through an application programming interface (API) 211 or similar structure. The API 211 is provided through an operating system, application or similar component of the system. Each write request indicates a log file, log, log event data, process information or similar data related to a log entry to be created.

In one embodiment, the mapped memory region 205 is a dynamically assigned region of the system memory or similar system resource. The mapped memory region 205 can be any size or have any configuration. The mapped memory region 205 may be internally divided or organized with separate sections for each process making entries or each section may correspond to a different section of a log file or different log files. The mapped memory region 205 is organized with each entry in chronological order. The API 211 enforces the organization of the mapped memory region 205. In one embodiment, the mapped memory region includes or is associated with status data to allow the entries to be maintained in chronological order when written to the log file.

In one embodiment, the log file 209 is stored in a persistent storage unit 207. The persistent storage unit 207 can be a magnetic fixed disk, an optical storage medium, a flash storage device or similar storage device. Any number of persistent storage units 207 may be present or utilized to store the log file 209. Redundant copies of a log file 209 can be stored on separate persistent storage units 207 or distributed across the persistent storage units 207.

Each log file 209 can be organized or configured as desired by an administrator or user. The log file 209 can be segmented into separate sections for each process or organized as whole with entries from each process interleaved with one another. The log file 209 can be chronologically or similarly ordered. The writing of entries from the mapped memory regions is carried out by a dedicated process 203 or similar mechanism. The location to which data entries are to be written in the log file 209 is fixed by the memory mapped relationship between the log file 209 and the memory region 205, where the address space of memory region 205 corresponds to or is mapped onto an address space of a portion or the whole of the log file 209.

FIG. 2B is a diagram of one embodiment of a system for managing a set of mapped memory regions where a second region has been activated. In one embodiment, after a first memory region 253 has been filled, then a new memory region 253 is allotted. The flushing process 251 is then assigned to the first memory region 253 to flush the data in the first memory region 253 to the log file 257 in the persistent storage system 259. The flushing process 251 can be any non-user related process 251. A user-related process is a process that is executing a service or application that is utilized by a user. The flushing process 251 can become blocked while flushing the contents of the first memory region without impact on the user and with minimum impact on overall server performance.

In one embodiment, a flushing process 251 is generated or instantiated when all process have been reassigned from a memory region. For example, when all of the processes 255 have been reassisgned from the first memory region 253 to a second memory region 259, because the first memory region 253 is full, the flushing process is assigned to the first memory region 253 to flush it. In this way all of the processes 255 continue to operate without being stalled to flush the first memory region. Also, it is often a requirement of an operating system that any memory resource always have an associated process. In another embodiment, the flushing process 251 is persistent and assigned to memory regions to be flushed as needed. In a further embodiment, a set of flushing processes is persistent and assigned to different memory regions as needed.

The other user related processes 255 are assigned to the second memory region 259. The second memory region 259 can be allotted, generated as needed, prepared in advance, permanently available or similarly managed. In one embodiment, a set of memory regions are made available as needed and the processes are assigned or reassigned to these memory regions as the memory region each process is using becomes full. The unused memory regions are then flushed by the flushing process 251 or a set of flushing processes.

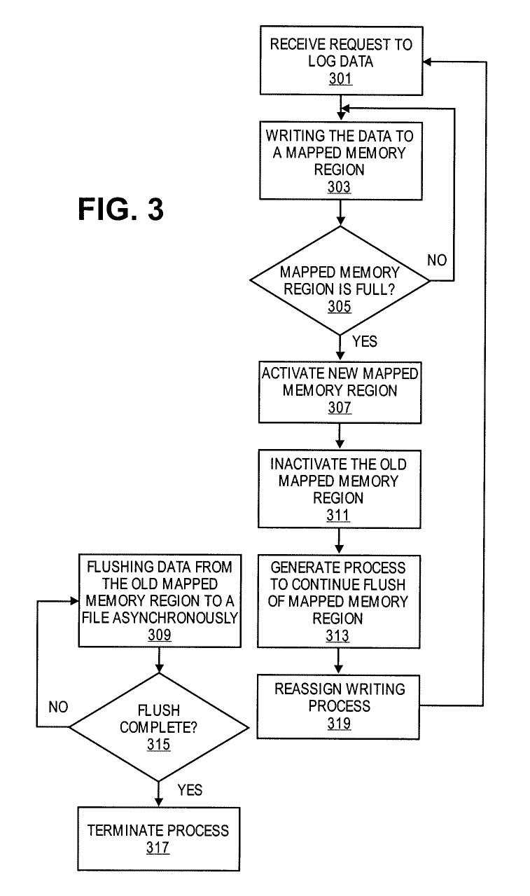

FIG. 3 is a flowchart of one embodiment of a process for managing the set of mapped memory regions. In one embodiment, the process of managing log events is initiated when a request is received from a process to service a write request to a log (block 301). In one embodiment, the write request writes data of a standard size to the log file. In another embodiment, the write request writes data to the log file, where the data has a variable length or size. This request can be handled by an API or similar component. The process determines which memory region is currently active and attempts to write the received data to the mapped memory region (block 303).

The process checks if there is sufficient space to write the entire log to the current mapped memory region (block 305). If the current mapped memory region is full then another mapped memory region is made active (block 307). The new mapped memory region needs to be allotted or similarly made available prior to activation. If the current mapped memory region is not full then the process completes the write of the data into the appropriate location in the mapped memory region that corresponds to the destination location in the log file.

In one embodiment, after the switch to another memory region the old memory region is inactivated (block 311). Inactivation indicates that processes are not to write to the memory region. The API or similar component tracks the status of each memory region in a status register or similar memory device or location. When a memory region is inactivated all processes are transferred or directed to write to the new active memory region. Before or at the time that the last user-related process is reassigned, the flushing process is assigned to the old memory region to flush the memory region to the file in the persistent storage device (block 313). The flushing process may be generated, instantiated or may already be running and be reassigned. In another embodiment, flushing processes, as well as, the memory regions are established during system start up or during a similar process.

If the process that attempted to write to the full memory region is the last process to be assigned to the memory region, then it is reassigned after the flushing process has been assigned to the full memory region (block 319). The memory management process then continues and handles the next write request that is received (block 301). In one embodiment, the management process handles multiple write requests in parallel. In another embodiment, the management process queues the requests and handles them serially.

The flushing process flushes the inactivated memory regions asynchronously from the main management process (block 309). As used in this context, ‘asynchronously’ refers to the operation of the flushing process being independent from the user-related processes and other management process functions such that it can perform the flush operation without blocking or waiting on the user-processes, thus, it is not synchronized with those processes. The asynchronous flush checks to determine if the flushing process has completed the flush of all data in a mapped memory region to the log file (block 315). Once, the flush process determines that all of the log entries have been written to the corresponding location in the log file according to the mapping between the log file and the memory region, then the flushing process terminates, releases or dissassociates from the memory region to terminate the memory region, release the memory region for reuse or similarly end the flushing of the memory region (block 317).

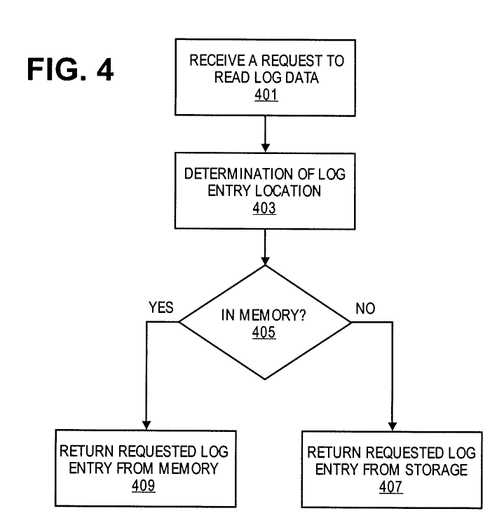

FIG. 4 is flowchart of one embodiment of a process for retrieving data from a memory region or a file. In one embodiment, the API or similar component facilitates the retrieval of log data. The log data may be in the log file where a requesting application is likely expecting the data to be located or it may be in the active or inactive memory regions, because it has not yet been flushed from those memory regions.

In one embodiment, this read assistance process receives a read request for specific data in a log file from a process or an application in the computer system (block 401). Any application or process may generate the request. The request may directly reference or call the read assistance process or the read assistance process may be triggered in response to a detection of an attempted access to the log file.

In one embodiment, the read assistance process determines which log and associated memory regions the requested data from the read request is associated with (block 403). For example, if a read request is for error data, then the error log and its associated mapped memory regions are checked for the requested data. In another embodiment, if it is not possible to determine an associated log when multiple logs are available, the request is tested, as follows, against each log and its associated memory regions. This check can be serially executed or can be executed in parallel.

The memory regions are first checked for the requested data (block 405). The memory regions have the fastest access time and if the requested data is found in the memory regions a check does not have to be made of any of the log files, which have a slow access time. All of the memory regions can be completely searched in less time than a single check of the log file. The search of the memory regions may use any search or data retrieval technique. If the requested data is found in memory then the data is retrieved from memory and returned to the requesting application (block 409). This process does not disturb the data in the memory, rather it makes a copy of the data to be returned to the requesting application and will be written to the log file asynchronously without modification. The retrieval of the data is transparent to the requesting application. The requesting application receives the data as if it were from the log file with the exception that the data is retrieved faster. If the data is not found in memory, then the data is retrieved from the log file (block 407). The log file may be searched or accessed using any data retrieval technique. The data is returned to the requesting application in a manner that is transparent. The requesting application does not know that a check was made of the memory regions or that its retrieval request has been intercepted. In another embodiment, a further check is made to determine if the data is in the log file. If the data is not in any log file, then an error message or indicator is returned to the requesting application.

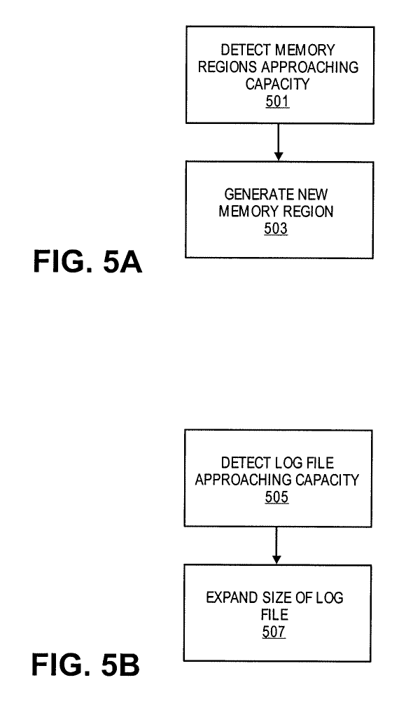

FIGS. 5A and 5B are flowcharts of one embodiment of a process for managing a log file and memory regions. FIG. 5A is a flowchart of the management of memory regions. In one embodiment, the memory regions are warmed up or generated before the currently active memory region is full. Alternatively, the memory regions do not have a static or maximum size. During a writing operation or similar operation a check is made by a user process, flushing process or similar process writing to the mapped memory region to determine if sufficient space is available in the mapped memory region to store all of the log entries in to be written for the write request or similarly queued data to be written to the mapped memory region (block 503). If the mapped memory region is determined to be of insufficient size or is approaching its full capacity, then a new mapped memory region is generated (block 503). In another embodiment, the mapped memory region can be expanded to a size sufficient to accommodate the queue or pending write requests (block 505). In one embodiment, the mapped memory region is resized based on a pending request. In another embodiment, the mapped memory region is expanded by fixed increments or similarly resized when its current size is to be exceeded.

FIG. 5B is a diagram of one embodiment of a process for managing a log file. In one embodiment, the log file does not have a static or maximum size. During a flushing operation or similar operation a check is made by the flushing process or similar process writing to the log file to determine if sufficient space is available in the log file to store all of the log entries in an inactive memory region or similarly queued data to be written to the log file (block 503). If the log file is determined to be of insufficient size, then the file is expanded to a size sufficient to accommodate the queue or pending write requests (block 505). In one embodiment, the log file is resized based on a pending request. In another embodiment, the log is expanded by fixed increments or similarly resized when its current size is to be exceeded.

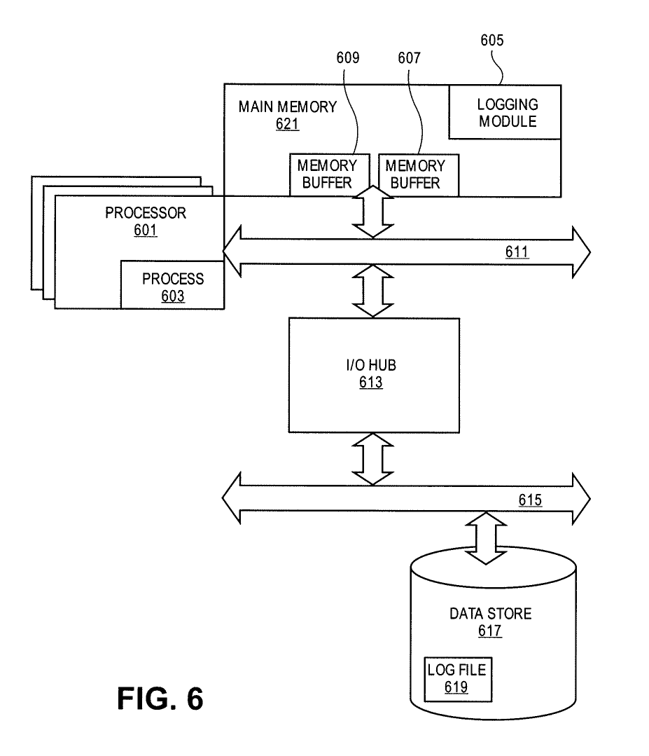

FIG. 6 is a diagram of one embodiment of a system for the memory mapped log file. In one embodiment, the system includes a set of processors 601 to execute a set of processes 603 as well as the operating system and other programs. The processes 603 may be applications and services that are also at least partially stored in the memory 621 and persistent data store 617. The processors 601 communicate with other system components over system busses 611, 613 and through any number of hubs 613. In other embodiments, the processors 601 and processes 603 communicate with other applications, services and machines over a network connection and through network devices connected to the system.

In one embodiment, the system includes a main memory 621. The main memory is used to store memory regions 607, 609 for short term and fast storage of log entries from the processes 603. The main memory 621 also stores a logging module 605, API code or similar implementation of the memory management processes. The logging module 605 is a program that is retrieved and executed by processors 601 or is separate from the main memory and a discrete device such as an application specific integrated circuit (ASIC) or similar device.

In embodiment, the system includes a persistent data store 617 such as a fixed mechanical disk, an optical storage medium, flash storage device or similar persistent storage device. The persistent data store 617 stores a log file 619 or set of log files. The persistent data store 627 also stores data or code related to other system components, applications and services. In another embodiment, the data store 617 is not directly coupled to the system and is accessible over a network connection, such as across the Internet or similar network.

In one embodiment, the log file management system including the logging module are implemented as hardware devices. In another embodiment, these components are implemented in software (e.g., microcode, assembly language or higher level languages). These software implementations are stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving a request to log data from any one of a plurality of processes;
writing a log entry in a first memory region responsive to receiving the request, the first memory region mapped to a file; and
flushing data from the first memory region to the file asynchronously.

2. The method of claim 1, further comprising:
detecting by a first process of the plurality of processes that the first memory region is full; and
inactivating the first memory region by the first process responsive to detecting the first memory region is full.

3. The method of claim 1, further comprising:
generating a process to flush the first memory region in response to detection of the first memory region being full.

4. The method of claim 1, wherein the request is a variable length write request.

5. The method of claim 1, further comprising:
determining whether the first memory region has sufficient space for an entire second request; and
writing a log entry in a second memory region responsive to receiving the second request if insufficient space is found in the first memory region.

6. The method of claim 1, further comprising:
receiving a request to read a log entry;
determining a location of the log entry; and
returning the log entry from the location.

7. The method of claim 1, further comprising:
setting an indicator in a third memory region, the indicator specifying an active memory region for each of the plurality of processes to write into.

8. The method of claim 3, further comprising:
terminating the process after the first memory region has been flushed.

9. The method of claim 1, further comprising:
warming up an inactive memory region prior to an active memory region becoming full.

10. The method of claim 1, further comprising:
increasing a size of the file in response to detection of a write to the first memory region that will exceed a current size of the file.

11. A system comprising:
a set of execution units to execute a plurality of processes, each of the plurality of processes to log activity; and
a logging module to receive requests to log activity from each of the plurality of processes, the logging module to asynchronously write log activity to a log file; and
a file system to store the log file.

12. The system of claim 11, wherein the logging module writes log requests to an active memory region, the active memory region mapped to the log file.

13. The system of claim 11, wherein the logging module increases a size of the log file to accommodate incoming log requests without blocking a requesting process.

14. The system of claim 11, wherein the logging module processes read requests for a log entry and locates the log entry within the memory regions or the log file.

15. A machine readable medium having instructions stored therein, which if executed by a machine, cause the machine to perform a set of operations comprising:
receiving data to be written to a file from any one of a plurality of processes;
storing the data in one of a plurality of memory buffers, each memory buffer mapped to the file; and
writing the data from the plurality of memory buffers to the file asynchronous with storing the data.

16. The machine readable medium of claim 15, having further instructions stored therein, which if executed by a machine, cause the machine to perform a set of further operations comprising:
maintaining status data for the plurality of memory buffers, the status data indicating one of the plurality of memory buffers as an active memory buffer.

17. The machine readable medium of claim 15, having further instructions stored therein, which if executed by a machine, cause the machine to perform a set of further operations comprising:
detecting an active memory buffer at capacity level; and
switching the active memory buffer to a different one of the plurality of memory buffers.

18. The machine readable medium of claim 15, having further instructions stored therein, which if executed by a machine, cause the machine to perform a set of further operations comprising:
extending a size of the file, if the data to be written causes the size to be exceeded.

19. The machine readable medium of claim 15, having further instructions stored therein, which if executed by a machine, cause the machine to perform a set of further operations comprising:
generating a memory buffer, if an active memory buffer is approaching its capacity.

20. The machine readable medium of claim 15, having further instructions stored therein, which if executed by a machine, cause the machine to perform a set of further operations comprising:
receiving a request for the data;
locating the data in one of the plurality of memory buffers; and
returning the data from the one of the plurality of memory buffers.

21. The machine readable medium of claim 20, having further instructions stored therein, which if executed by a machine, cause the machine to perform a set of further operations comprising:
attaching a process to a memory buffer to flush the memory buffer if the memory buffer is full.

22. The machine readable medium of claim 21, having further instructions stored therein, which if executed by a machine, cause the machine to perform a set of further operations comprising:
terminating the process after the memory buffer has been flushed.
